(19) United States
(12) Patent Application Publication
(10) Pub. No.: US 2019/0034863 A1
(43) Pub. Date: Jan. 31, 2019

(54) SHIPPING ACCURACY

(71) Applicant: Walmart Apollo, LLC, Bentonville, AR (US)

(72) Inventors: David C. Winkle, Bella Vista, AR (US); Greg A. Bryan, Centerton, AR (US); Benjamin D. Enssle, Bella Vista, AR (US); Bruce W. Wilkinson, Rogers, AR (US); Cristy C. Brooks, Cassville, MO (US)

(21) Appl. No.: 16/039,702

(22) Filed: Jul. 19, 2018

Related U.S. Application Data
(60) Provisional application No. 62/535,464, filed on Jul. 21, 2017.

(51) Int. Cl. G06Q 10/08; B65D 19/38; G06F 3/041; B65D 19/02

(52) U.S. Cl. CPC G06Q 10/087; B65D 19/38; B65D 2519/0086; B65D 19/02; G06F 3/041

(57) ABSTRACT

In some embodiments, apparatuses and methods are provided herein useful to monitor the status of products loaded on or in a pallet, container, or other transport or storage structure and/or provide handling instructions. In some embodiments, one or more sensors detect one or more characteristics such as location, mass, temperature, or humidity, and a display device mounted to the transport or storage structure indicates whether detected values from the sensors are within acceptable ranges.

### CROSS-REFERENCE TO RELATED APPLICATION(S)

This application claims the benefit of U.S. Provisional Application No. 62/535,464, filed Jul. 21, 2017, which is incorporated by reference in its entirety herein.

### TECHNICAL FIELD

This invention relates generally to pallets, containers, and other devices to carry or hold items.

### BACKGROUND

Items shipped from one destination to another are often grouped with other items of the same type or with other related items on pallets or in containers. These groups of items may also have related care instructions or other requirements for shipping conditions. Determining whether a container or pallet has been properly loaded and maintained during shipping or storage can be a labor intensive process. Certain automated systems have been proposed for automating the process of verifying proper loading of pallets and monitoring conditions such as temperature within the transporting vehicle. However, these automated systems do not ordinarily monitor the pallet or container throughout the shipping process and require individual pallets to be identified by scanning or entering an identification number prior to obtaining information about pallet condition.

### BRIEF DESCRIPTION OF THE DRAWINGS

Disclosed herein are embodiments of systems, apparatuses and methods pertaining pallets, containers, and other transportation structures equipped with one or more sensors and a display device to display information detected by the sensors regarding the condition of goods placed on or in the transportation structure. This description includes drawings, wherein:

FIG. 1 is a diagram of the components of a device for monitoring items placed on a pallet or in a container in accordance with some embodiments.

FIG. 2 is a perspective view of an exemplary pallet in accordance with several embodiments.

FIG. 3 is a perspective view of an exemplary container in accordance with some embodiments.

FIG. 4 is a simplified flow diagram illustrating sensor logic in accordance with several embodiments.

FIG. 5 is a simplified flow diagram of a method of monitoring goods in accordance with some embodiments.

FIG. 6 is a flow diagram illustrating a logic process of a pallet in a system including multiple pallets in accordance with some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to various embodiments, systems, apparatuses and methods are provided herein useful to minimize delivery errors or to verify that a pallet, container, or other transportation structure used for shipping or storage is properly loaded and/or that its contents are within acceptable parameters. In some forms, a system compares order details to sensor data in order to verify correct handling of transportation structures and display resulting status information. In some embodiments, the transportation structure includes one or more sensors for measuring one or more characteristics of one or more items placed on or in the structure, and a display in communication with the one or more sensors for indicating whether the measured characteristics are within acceptable parameters. Sensors may be grouped in an array of sensors, and may be arranged, in some applications, as multiple individual sensors, multiple individual sensor strips of sensors, and/or a sensing grid or matrix of sensors. In some implementations, one or more sensors may be secured with and/or embedded into the pallet. In other implementations, an array of sensors may include a casing with the sensors of the array be positioned with the casing and distributed in a known pattern (e.g., strip, matrix, grid, etc.). In some embodiments, a display screen is mounted on or in the transportation structure to provide information regarding sensor readings without the need for additional instruments or apparatus. In this way, a user, such as a delivery vehicle driver or sales associate, may tell with a quick glance or the touch of a few buttons whether the transportation structure is properly loaded and maintained without the need to look up an identification number or scan the transportation structure with a separate device. While the devices, systems, and methods discussed herein will primarily refer to pallets, it will be understood that any type of transport structure may be employed, such as platforms, planks, or containers of any shape or size. The transport structure also may be incorporated into another device or structure, such as integrated into a motorized transport vehicle or a shelf of a storage unit.

The devices and methods discussed herein may assist in avoidance of over- or under-shipment of goods, correct loading and unloading of goods, improving accuracy of shipped contents and shipping dates, proper handling of goods, and even improving efficiency of loading and arranging goods for transport. In some embodiments, a portable platform for conveying and storing a plurality of products is provided, the platform comprising a base configured and sized to carry and support the plurality of products, a control circuit coupled to the base, at least one sensor coupled to the control circuit, a computer memory comprising a database containing data regarding acceptable parameters for readings from the at least one sensor; a power source; and a display physically connected to the platform and coupled to the control circuit, the control circuit configured to cause the display to provide an indicator showing that the readings from the at least one sensor matches or does not match the acceptable parameters of the database. The at least one sensor may be configured to detect at least one of position, pressure, conductivity, acceleration, temperature, or humidity.

In some embodiments, a portable transportation structure is provided for conveying and storing a plurality of products at least at a product sales supply chain facility, the portable structure comprising a base configured and sized to carry and support the plurality of products and further configured to be carried and transported by a motorized lift unit; a control circuit coupled to the base; a global positioning system unit coupled to the control circuit; a pressure sensor coupled to the control circuit; a conductivity meter coupled to the control circuit; an accelerometer coupled to the control circuit; a temperature sensor coupled to the control circuit; a humidity sensor coupled to the control circuit; a computer memory coupled to the control circuit, the computer memory comprising a database containing data regarding acceptable parameters for readings from at least one of the sensors and including parameters for pallet location, item weight, electrical conductivity, acceleration, temperature, and humidity; and a display mounted to the structure and coupled to the control circuit, the control circuit configured to cause the display to provide an indicator showing that the readings from one or more of the global positioning system, pressure sensor, conductivity meter, accelerometer, temperature sensor, and humidity sensor match or do not match the acceptable parameters of the database.

The transportation structures according to various embodiments may be any structure capable of supporting one or more goods for shipping. In some embodiments, the transportation structure is a traditional pallet made of wood or other rigid materials, as is commonly used in warehouses and shipping facilities. The pallet or other structure may comprise only a base, or may include one, two, three, or more sidewalls attached to a base to form a container, and may optionally also have a top or lid. While various embodiments will be described herein with respect to pallets, the principles of operation apply equally to containers and other structures for transporting goods. In some embodiments, the pallet or container may be of a standard or uniform size and shape for conveying and storing a plurality of products at least at a product sales supply chain facility. In some embodiments, the pallet or container may be 36-48 inches wide and 36-48 inches deep. In some embodiments, especially for use in supply chain facilities in the United States, the base of the pallet or container may be about 48 inches by about 40 inches and about 6.4 inches tall. In some embodiments, the pallet or container may be larger or smaller, depending on the preferences of the user or type of goods to be transported. For instance, in some embodiments, the base of the pallet or container may be only several inches in width and length if it is to be carried by hand. In some embodiments, the pallet or container also may be designed for display, such as on a fixed shelf in a retail facility.

In some embodiments, the pallet or container may have a pair of spaced apart slots at the lower end for receiving prongs of a forklift or similar apparatus. The pallet or container may be made from wood, plastic, metal, or any other suitable rigid material. In some embodiments, the pallet or container may be configured for interacting with another structure. For instance, the pallet may include an input and/or output for plugging into or coupling to a shelf or other fixed structure in order to send or receive data through the fixed structure.

Any number and type of sensors may be incorporated into the pallet in order to provide information about the status of the pallet or goods associated therewith. For instance, in some embodiments, the pallet may include a global positioning system unit in order to detect and track the physical location of the pallet/container. Pallets could alternatively, or additionally, be tracked by RFID, bar codes, serialized barcodes, QR codes (matrix barcodes), light emitting diodes, or other techniques. In some embodiments, the pallet may include an RFID reader, magnetic sensor, optical sensor, or other sensor to identify goods located onto the pallet marked with an identifier that can be detected by the sensor. In some embodiments, the pallet may include a pressure sensor, such as a piezoelectric mat, for measuring the mass or weight of goods placed on or in the pallet. In this way, when the number of items scheduled to be loaded on the pallet and the mass/weight of each item is known, the device can determine whether the detected mass/weight corresponds to the scheduled loading of the pallet. In some embodiments, the pallet may comprise a conductivity meter, which can detect changes in electrical conductivity on the pallet that are indicative of the presence of unwanted liquids, for instance by leaking of goods placed on the pallet, flooding, or rain. In some embodiments, the pallet may include an accelerometer to measure movement of the pallet and impacts thereto, which information may be used to determine if an event occurs that has the potential to damage the goods contained on the pallet. In some embodiments, the pallet may include a temperature sensor for use in determining whether heat (or lack thereof) may have compromised goods placed on the pallet. In some embodiments, the pallet may include a humidity sensor for use in determining whether the level of moisture in the atmosphere near the pallet has the potential to damage facilitating the growth of mold. Multiple of such sensor or array of sensors may be utilized within a single pallet. Details of the structure and makeup of these sensors, as well as their connectivity, will be well known to those of ordinary skill in the art.

Other sensors may additionally or alternatively be included in an array and/or separate from an array. For example, some embodiments include one or more gas emission sensors, light sensors, motion sensors, and/or other such sensors. Gas emission types of sensors are useful, for example, in detecting chemicals that may be associated with deteriorating conditions of certain perishable items, such as, for example, certain types of fruit. The types of sensors used may be selected and customized to the particular nature of the products and/or pallets (or other product support). In some embodiments, the sensors may be determined or selected based on the perishable nature of the products.

A communication cable, port, or the like that allows the sensors to communicatively couple with a pallet control system may be provided. Additionally or alternatively, a wireless transceiver can be included with the sensor array to provide wireless communication, such as to a pallet control system, a central control system, a worker's interface unit (e.g., smartphone, tablet, computer, etc.), and/or other devices. In some applications, one or more power sources (e.g., rechargeable and/or replaceable battery, capacitor, or the like) can be provided to supply power to the sensors, control circuit, display, and other components of the pallet.

Each type of sensor may be coupled to a control circuit that receives signals from the sensor, or multiple sensors, and compares detected signals from the sensors to acceptable ranges listed in a database contained in a computer memory. The sensors may be coupled to the control circuit in any known manner. In some embodiments the sensors are hard wired to the control circuit and to the display; in other embodiments the sensors communicate with the control circuit through radio frequency signaling, Bluetooth, Wi-Fi, or other local area wireless systems. The control circuit may be equipped with a power supply, data ports, and/or a network interface.

In some embodiments, the control circuit causes an alert to be presented on the display when a reading from one or more of the sensors does not fall within the acceptable range listed in the database. In some embodiments, the display may show that all readings are within acceptable ranges, and cease showing an acceptable reading when a sensor detects a measurement outside of the acceptable range. In some embodiments, only unacceptable readings are noted on the display, while in other embodiments the display continuously presents information regarding sensor readings. In some embodiments, the display presents information from the sensors only when prompted by a user.

In some embodiments, the display is configured to convey separate information about each type of sensor associated with the pallet, for instance with a separate indicator light associated with each sensor. In some embodiments, the display comprises a plurality of indicator lights, each indicator light corresponding to one of the global positioning system, pressure sensor, conductivity meter, accelerometer, temperature sensor, and humidity sensor. In some embodiments, the control circuit activates the indicator lights when the readings do not match the acceptable parameters. The indicator lights may comprise, for instance, light emitting diodes. Alternatively, in some embodiments the display comprises a liquid crystal display screen, a thin-film-transistor liquid-crystal display, a light emitting diode screen, or an organic light emitting diode screen. In some embodiments, the display is a touch-screen display. In some embodiments, the display is upwardly facing so as to be easily viewed from above when positioned on the ground. In some embodiments, the display is mounted to a base of a pallet or recessed within the base of a pallet. In some embodiments a plurality of walls extend upwardly from the base of a pallet and the display is mounted directly to one of the walls or is recessed within one of the walls. In some embodiments, a power source is physically connected to the pallet base or wall and to the display.

In some embodiments, a sensor may detect the presence of RFID tags, QR codes, color codes, bar codes, or other identifiers disposed on goods to be loaded onto a pallet or into a container to confirm that the appropriate number of goods have been loaded and/or that goods have been loaded in the appropriate positions and/or sequence. The display then indicates whether the pallet or container is properly loaded, and in some embodiments may display recommendations for corrective action if the goods have not been properly loaded. In some forms, the pallet may perform continuous self-assessment using integrated sensors and display a related status on the integrated display and/or a remote display. If the pallet position, for instance within a transport vehicle, does not match a loading plan at any given point in time, the pallet may display a handling or loading error, in some instances with precise details relating to the nature of the handling or loading error. In some forms, a pallet incorrectly placed at the tail end of a truck trailer may display an error if the load plan specifies loading at the head of the trailer. This error alerts workers to incorrect placement of the pallet in order to reduce the risk of premature unloading, and may in some forms include information regarding corrective action to be taken in order to properly unload the pallet. Failure to maintain required conditions, such as when the ambient temperature surrounding the pallet is insufficient to maintain cold chain requirements or does not match the temperature of the intended destination, may also result in the generation of error signals.

Handling instructions for pallets also may be displayed in order to instruct workers. In some forms, integrated displays on the pallets may indicate the sequence of unloading and/or specific handing instructions, either through lighted indicators, written text, graphical indications, or other methods. Alternatively, or in addition, a remote controlled light (or array of lights) mounted within the environment (e.g. within a truck trailer or at a loading dock) may be used to communicate information regarding loading or unloading sequence or handling instructions. For instance, the remote controlled light may be directed to the next pallet in the loading/unloading sequence to allow workers to quickly determine which pallet to load or unload next. The remote controlled light may also be configured to change colors in order to provide information, such as turning red if an error has been made or to indicate that fragile goods are carried on the pallet. The display and/or remote controlled light may be controlled by one or more control circuits located on pallets or by one or more remote servers.

When feasible for pallets to interconnect using data ports or network access, location and status data may be exchanged between pallets. Sensor data from each pallet may be compared to scheduling details, allowing pallets to identify and communicate which pallet was the last to be handled and which is scheduled to be handled next. If necessary, scheduling information and handling sequence can be altered as requirements change.

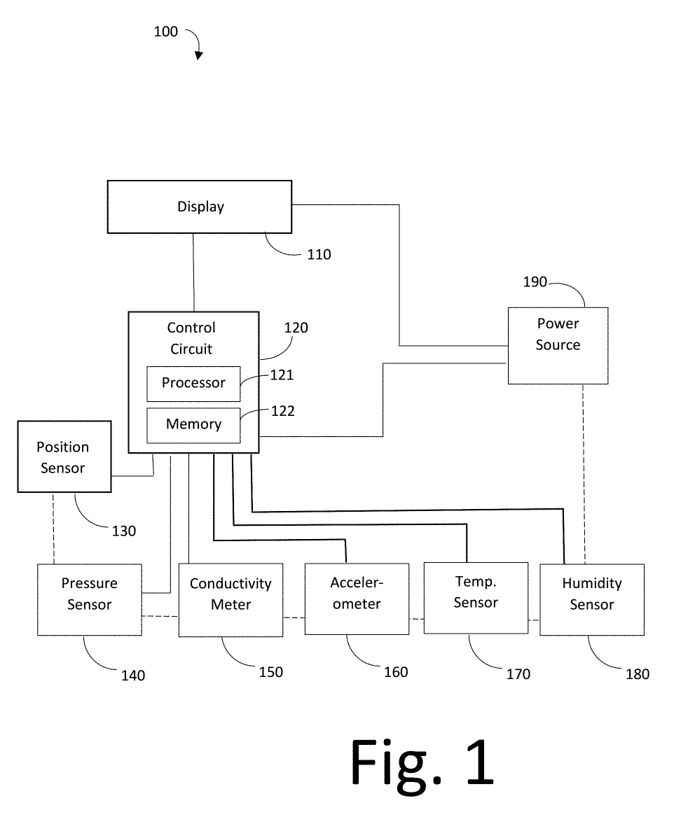

As shown in FIG. 1, in one form a device 100 includes a display device 110 coupled to a control circuit 120, which causes the display device 110 to show information corresponding to one or more sensors coupled to the control circuit. The control circuit may include a processor 121 and memory module 122. The term control circuit refers broadly to any microcontroller, computer, or processor-based device with processor, memory, and programmable input/output peripherals, which is generally designed to govern the operation of other components and devices. It is further understood to include common accompanying accessory devices. The control circuit can be implemented through one or more processors, microprocessors, central processing units, logic, local digital storage, firmware, software, and/or other control hardware and/or software, and may be used to execute or assist in executing the steps of the processes, methods, functionality, and techniques described herein. Furthermore, in some implementations the control circuit may provide multiprocessor functionality. These architectural options are well known and understood in the art and require no further description here. The control circuit 120 may be configured (for example, by using corresponding programming stored in a memory as will be well understood by those skilled in the art) to carry out one or more of the steps, actions, and/or functions described herein.

Generally, the control circuit 120 can include fixed-purpose hard-wired platforms or can comprise a partially or wholly programmable platform. These architectural options are well known and understood in the art and require no further description here. The control circuit can be configured (for example, by using corresponding programming as will be well understood by those skilled in the art) to carry out one or more of the steps, actions, and/or functions described herein, and can store instructions, code, and the like that is implemented by the control circuit and/or processors to implement intended functionality. In some applications, the control circuit and/or memory may be distributed over a communications network (e.g. LAN, WAN, Internet) providing distributed and/or redundant processing and functionality. In some implementations, the control circuit can comprise a processor 121 and a memory module 122, which may be integrated together, such as in a microcontroller, application specification integrated circuit, field programmable gate array or other such device, or may be separate devices coupled together.

The device of FIG. 1 includes a plurality of sensors in communication with the control circuit 120. A position sensor 130, pressure sensor 140, conductivity meter 150, accelerometer 160, temperature sensor 170, and humidity sensor 180 are all shown to be coupled to the control circuit 120. In particular embodiments, one or more of these sensors may be included to provide the control circuit with information regarding the status of goods positioned on a pallet. Other types of sensors may also be included. Two or more sensors may be combined into a single device if desired. A power source 190 such as a battery is provided to power the control circuit 120 and/or display 110. Multiple power sources may also be employed, with the display and control circuit each having a separate power source. The power source 190 may also provide power to one or more sensors, although the sensors may alternatively have their own power source or sources. The power source may also be external to the device 100, such as a power supply at a docking station that connects to the display 110, control circuit 120, and/or sensors when the device 100 is appropriately positioned.

Signals from the sensors are received by the control circuit 120 and compared to values in a database of the memory 122 defining acceptable and unacceptable parameters for each type of signal. The database may contain extensive information regarding shipping routes, shipping schedules, vehicle manifests, and/or handling requirements. The control circuit then transmits signals to the display 110 to provide indicators of the status of each sensor. In some embodiments, the indicator may simply be a single light, where the light is turned on when all sensor readings are acceptable and turned off when one or more sensor readings are unacceptable, or vice versa. In some embodiments, the display has one or more separate indicators for each sensor. In some embodiments, the display may comprise LEDs that emit light of different visible wavelengths depending on the status indicated by each sensor, for instance green if the corresponding sensor reading is acceptable or red if the reading is unacceptable. In some embodiments, the display may present letters, symbols, shapes, or other visual indicators of sensor status.

In some embodiments, the display may be a screen such as a liquid crystal display screen, thin-film-transistor liquid crystal display screen, or LED/OLED display screens. In some embodiments, the screen may display extensive information regarding sensor readings, including actual measurements detected by the various sensors, and in some embodiments may display corrective action suggested by the control circuit in response to detected measurements. For instance, if the mass of items detected on a pallet exceeds the mass of goods to be transported, the display may state “Overloaded—remove X number of items” wherein X is calculated to be the number of items to be removed based upon the mass and number of items to be shipped. Alternatively, the screen may indicate how many items are to be added if the mass of goods is detected to be below a designated capacity. The display may also indicate that goods should be checked for damage or spoilage if certain conditions are detected. If a pallet or container is used for storage or display of items to be sold, the display may be configured to indicate whether stored goods need to be restocked. Optionally, auditory signals may also be sent from the display or another device to indicate whether various parameters are acceptable or unacceptable, such as a beeping or buzzing sound when a sensor indicates that a parameter is not within a defined acceptable range.

The position sensor 130 may be any device that permits position measurement, either absolute or relative. The position sensor provides information regarding the physical location of the device 100, allowing the control circuit 120 to determine whether the pallet or container itself is in the appropriate position. In some embodiments, the position sensor 130 is a GPS or DGPS device configured to provide satellite-based geolocation information. In some embodiments, the position sensor 130 may determine position through proximity to a fixed locator device, such as a transmitter placed at a specific point in a transport vehicle or warehouse. In some embodiments, the position sensor may be configured to determine when the pallet enters or exits a geofenced area. In some embodiments, the control circuit 120 may be further in communication with other pallets or containers or an external server in order to determine if the pallet or container has been loaded in the appropriate order or location relative to other pallets or containers.

The pressure sensor 140 may be a sensor or series of sensors configured to measure the mass of objects loaded on the pallet or container base. Where a plurality of items are to be loaded onto a pallet, the control circuit 120 may take into account the individual weight of each item and the number of items to be loaded to calculate the total mass to be loaded, and then determine whether the pallet has been loaded with too many or too few items. The pressure sensor may also comprise a plurality of sensors spaced apart to determine whether the loaded items are appropriately distributed across a surface of the pallet. In some embodiments, the pressure sensor 140 comprises a plurality of sensors spaced uniformly in a grid to provide information regarding the distribution of mass across a surface of the pallet or container. In some embodiments, the pressure sensor is a piezoelectric mat configured to provide information regarding mechanical stress applied across the surface of the mat. In some embodiments, an alert could be generated and maintained if the mass of loaded goods was below a specified threshold at any point after loading, thus indicating potential tampering and warning a user to inspect the goods. In addition to, or in place of, the pressure sensor(s), other types of sensors may be provided to detect the presence, absence, and/or position of loaded goods, such as optical sensors, radio frequency sensors, magnetic sensors, or other sensors configured to detect particular loaded goods.

The conductivity meter 150 may be of any known type. In some embodiments, the conductivity meter comprises electrodes distributed across a surface to detect changes in conductivity over a large area. In other embodiments, the conductivity meter is configured to detect changes in conductivity over a small area. In some embodiments, the conductivity meter may be used to detect spills of liquid product loaded on the pallet or container. In some embodiments, the conductivity meter detects the presence of water or other liquids to provide an alert where the goods loaded on the pallet or container are sensitive to liquids or moisture.

The accelerometer 160 detects movement of the pallet or container, and may be coupled with a gyroscope or other device to provide information regarding the direction of movement. The accelerometer may be of any known type. Where goods loaded on the device are frangible, the database coupled to the control circuit may contain information regarding levels of force likely to damage the goods so that detection of impacts or sudden movement/stoppage of the pallet or container detected by the accelerometer may be used by the control circuit 120 to determine whether the movement was potentially damaging to the goods. For instance, if sudden movements detected by the accelerometer are indicative of an impact to the pallet or container having a force that exceeds a predefined threshold, the control circuit 120 may cause the display to show an alert instructing a user to check the goods on the pallet or container for damage.

The temperature sensor 170 may be of any known type, and may be positioned and configured to detect the temperature of the pallet or container, the temperature within the pallet or container, the temperature of the environment surrounding the pallet, and/or the temperature of goods placed on the pallet. In some embodiments, the control circuit 120 may cause the display 110 to cause an alert if the detected temperature is above and/or below a designated acceptable range at any point. In some embodiments, the display may only show an alert if the detected temperature is outside of the designated acceptable range for a designated period of time. In some embodiments, the control circuit 120 may be configured to cause the display 110 to show the current temperature and/or a temperature history detected by the temperature sensor.

The humidity sensor 180 may be of any known type, and may be positioned and configured to detect the humidity of the environment surrounding the pallet container, or the humidity at a specific on or within the pallet or container. In some embodiments, the control circuit 120 may cause the display 110 to cause an alert if the detected humidity level is above and/or below a designated acceptable range at any point. In some embodiments, the display may only show an alert if the detected humidity is outside of the designated acceptable range for a designated period of time. In some embodiments, the control circuit 120 may be configured to cause the display 110 to show the current humidity and/or a humidity history detected by the humidity sensor.

Multiple sensors of each type described above may be provided for a single pallet or container. In some embodiments, one or more of the described types of sensors may also be omitted. Thresholds defining acceptable ranges for each type of sensor may be determined based on the type of goods to be placed on the pallet or container and stored in the database that is in communication with the control circuit 120. The control circuit 120 may further allow a user to select specific acceptable ranges or select from preset ranges based on the type of goods to be loaded.

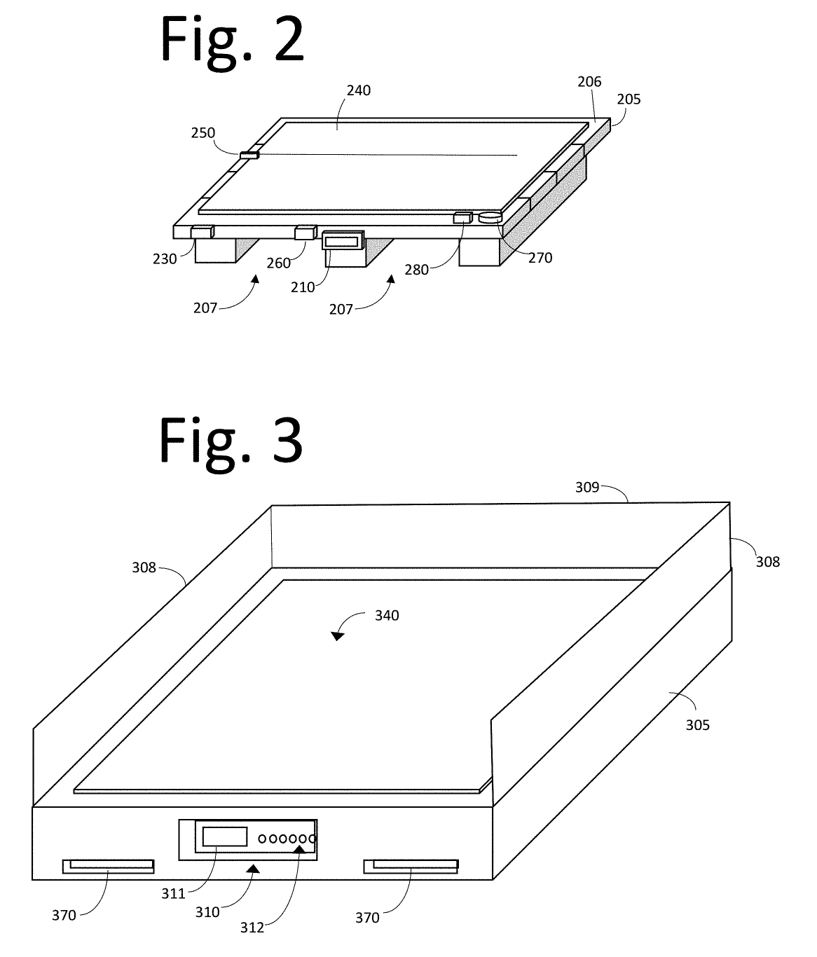

One example of a pallet apparatus as provided herein is illustrated in FIG. 2. A standard warehouse pallet 205 is equipped on its upper surface 206 with a piezoelectric mat 240 for detecting the presence and distribution of loaded items. Slots or opening 207 at the lower end of the pallet 205 allow the pallet to be easily lifted off of the floor and manipulated using a motorized lift device such as a forklift. A conductivity sensor 250 is also configured to detect changes in electrical conductivity across an area of the upper surface 206 of the pallet 205 to detect the presence of water or other liquids. A GPS receiver 230, accelerometer 260, thermometer 270, and humidity sensor 280 are also mounted to the pallet 205. Each sensor is in communication with a display screen 210 mounted to the front of the pallet. The display screen 210 may be mounted to any part of the pallet as desired according to preferences of the user. In some instances, such as where users will be standing over or walking past pallets at floor level, it may be more desirable to mount the display screen 210 on the upper surface 206 of the pallet so that it is in the user's line of sight, whereas mounting on the front or other side surface of the pallet is likely preferred where the pallets will be stacked, such as on shelving units. If desired, the display device 210 may be positioned within a recess in the pallet to protect the device from damage.

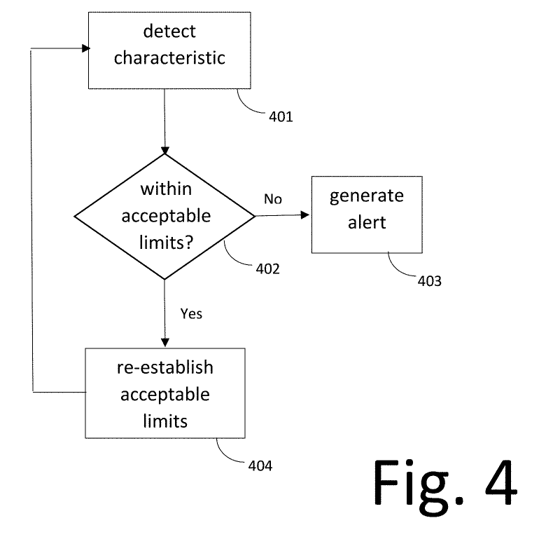

The pallet may be of any other configuration for transporting or storing goods. FIG. 3 shows another exemplary transport device according to some embodiments comprising a pallet base 305 and a display device 310. The illustrated pallet base 305 may include slots 370 or other structures for receiving forks of a motorized lift or other instruments for moving and manipulating the pallet. In some embodiments, the slots 370 may be configured to receive human hands for carrying the pallet, or may alternatively be formed as handles or other structures that assist in lifting, carrying, and manipulating the pallet.

The pallet shown in FIG. 3 further includes sidewalls 308 and a rear wall 309 extending upwardly from the pallet base 305 to form a container. A front wall also may be provided if desired. Each of the wall structures optionally may be removable, hinged to the pallet base 305, or otherwise designed to allow for various configurations.

The upper surface of pallet base 305 is covered by a piezoelectric mat for detecting the presence and distribution of goods loaded thereon. A variety of sensors are also present. The display device 310 displays information detected by the various sensors. As shown, the display device 310 is recessed within the front face of the pallet base 305 to minimize damage to the display device 310 during handling. The display device 310 includes a screen 311 and buttons 312 for selecting what information is displayed on the screen. In some embodiments, each button may be associated with a specific sensor, allowing a user to select specific buttons to cause the screen 311 to show information detected by specific sensors. In some embodiments, these buttons may light up, turn different colors, or otherwise change in appearance depending upon whether the characteristic detected by the associated sensor is within an acceptable or unacceptable range. For instance, if the temperature detected by the pallet is outside of the acceptable range, the corresponding button on the device might change from green to red, and pushing the button would result in information regarding temperature history to appear on the screen 311. In some embodiments, the buttons 312 may be displayed on or part of the screen 311 as in a touchscreen device.

The control circuit may take into account multiple sensor inputs when generating alerts. For instance, the control circuit might simultaneously compare readings from the pressure sensor, GPS coordinates, and time values to predetermined acceptable values contained in a scheduling database in order to determine if the right number of items are being unloaded from the pallet at the correct location at the correct time. If any of the parameters do not match the schedule or anticipated values, an alert could be generated. The alert may be a simple error signal, or may provide a suggested corrective course of action to bring detected values into conformance with the schedule. For instance, the display may suggest that the user replace a certain number of items, or move the location of the pallet before unloading. With the display mounted on the pallet, there is no need to consult a terminal or mobile device to determine whether the pallet is being properly handled, and the pallet is capable of providing necessary information to users even when a local network is absent or unavailable. In addition, the information is readily accessible without the need to scan the pallet, and in some embodiments alerts may be presented to users without any need to interact with the pallet so that errors in loading or handling can be identified my users within seconds just by looking at the pallet.

Any of the sensors or components of the control circuit may be located outside of the pallet if desired. For instance, the control circuit may be located remotely and communicate with sensors and a display mounted to the pallet via LAN, WAN, or the internet. In some embodiments, a control circuit and a power source may be located in a shelf or other fixed structure within a vehicle or warehouse so that the pallet may be connected to the fixed structure in order to link a pallet-mounted display and sensors to the control circuit and power source. For instance, the pallet may be configured to be docked at a specified point in a delivery vehicle, at which point it would have access to hardware and software of the docking station. Certain sensors may be located in the vehicle apart from the pallet and accessible through a connection to the docking station.

Details regarding acceptable parameters and other information may be uploaded to the pallet or downloaded by the pallet through a data port or network interface coupled to the pallet's control circuit. Data provided to the control circuit may include, but is not limited to, delivery destination, items to be loaded on the pallet, anticipated item characteristics, and/or item handling requirements. Items placed on the pallet may be scanned, and then scanned data transmitted to the pallet's control circuit. Alternatively, or additionally, a database of product characteristics or features of the products anticipated to be placed on the pallet may be uploaded to the pallet's control circuit or located on an external or cloud-based server accessible by the pallet's control circuit.

FIG. 4 illustrates how a device monitors a detected characteristic over time. At step 401, a device detects one or more characteristics through one or more sensors. The control circuit receives information regarding the detected characteristics and makes a determination (Step 402) as to whether the detected characteristic is within acceptable limits. For instance, the control circuit may determine whether a detected value exceeds a predefined minimum value and is below a predefined maximum value. If the detected value for the characteristic is not within the predefined acceptable limits, the control circuit will generate an alert (Step 403) to be displayed on a display device. If the control circuit determines that the detected value is within acceptable limits, it will re-establish acceptable limits (Step 404) as selected factors change. For instance, Step 404 may be performed periodically as time progresses, or may be performed in response to another detected characteristic such as location. Once the acceptable limits are re-established, the sensor will again detect characteristics (Step 401) and determine whether the detected value is within the new acceptable limits (Step 402)

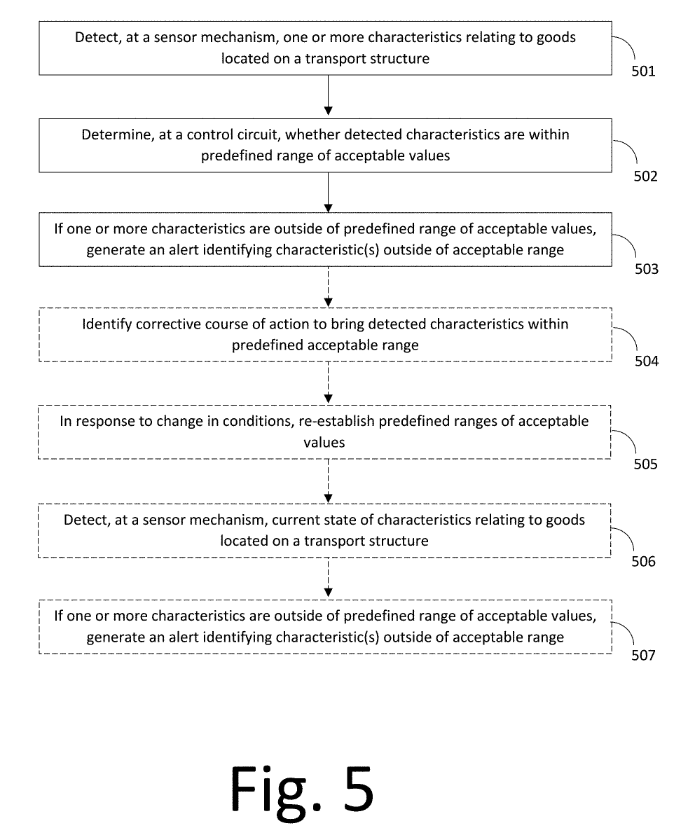

In some embodiments, as shown in FIG. 5, an apparatus for identifying the status of a pallet or container detects, at a sensor mechanism, one or more characteristics relating to goods located on a transport structure (Step 501); determines, at a control circuit, whether one or more detected characteristics are within predefined ranges of acceptable values relating to the detected characteristics (Step 502); and if one or more characteristics are outside of the predefined ranges of acceptable values, the control circuit generates an alert identifying characteristics outside of acceptable ranges to be displayed on an integrated display device (Step 503). In some embodiments, the alert may include an identification of a corrective course of action to bring the detected characteristic within the predefined acceptable range (Step 504). In some embodiments, the control circuit will re-establish the predefined ranges of acceptable values in response to a change in conditions (Step 505), such as a change in position, change in time, or change in mass, and then detect the current state of the characteristic (Step 506) to determine if the characteristic is within a new predefined acceptable range of values so that an alert may be generated if the current state is within the new acceptable range (Step 507).

In some forms, the pallet displays may provide a user with information regarding the proper sequence of loading or unloading. For instance, a system for light-directed staging may be implemented in a loading or unloading operation to quickly call a worker's attention to the next pallet to be loaded or unloaded. In some forms, this light directed staging could include sequential lighting of pallet-mounted displays and/or sequential illumination using directed lighting from a fixed source within a truck or loading dock. In some forms, a method of identifying a sequence in which to move a plurality of portable structures may comprise a scheduling device referencing a database to identify the first portable structure to be moved, communicating with a first control circuit of the first portable structures to be moved in order to cause the first control circuit to display a status indicator, receiving confirmation that the first portable structure has been moved, and then referencing the database to identify the next portable structure to be moved. This sequence may be repeated as necessary until all portable structures have been moved. For instance, the display of the next pallet to be loaded into or removed from a vehicle may be illuminated or caused to display a specified message in order to call it to the pallet to the attention of the individuals loading or unloading the vehicle. In one example, a plurality of pallets transported by truck may sequentially display green lights to indicate their status as the next item to be removed according to a schedule, such as a bill of lading. Alternatively, the pallets other than the next to be unloaded could be configured to display a red light or other message indicating that it is not their turn to be unloaded. A system also may use external devices to generate signals cues, such as one or more spotlights that illuminate the next pallet to be moved or an external display screen (such as a screen mounted within the truck or on a handheld device) that shows an identification symbol (e.g. letter, number, or picture) corresponding to the next pallet to be unloaded.

In order to identify the proper sequence for unloading, control circuits on a plurality of pallets may communicate with a central server that issues instructions to the pallets individually. For instance, in some forms when the central server receives confirmation that the pallets are received at a loading dock, either from a sensor that identifies the presence of the pallets or from communications from one or more of the pallets indicating their position, the server will reference a database, such as a bill of lading, to identify the first pallet scheduled to be unloaded. The server will then transmit a signal to a control circuit of the identified first pallet, causing the control circuit of the first pallet to signal an associated display device to display an indicator that the first pallet is scheduled to be moved next. As the pallet is moved, a sensor of the first pallet and/or a remote sensor will determine that the first pallet has been moved. For example, a GPS unit on the first pallet may determine that the pallet has been moved from its starting location to another location. Alternatively, an optical sensor on the pallet may recognize that the pallet has been moved to a different area based on symbols (e.g. numbers, letters, or UPC or QR codes) in a surrounding area or along the path of transport. As another option, the pallet may contain a RFID tag or other transmitter that is identified by one or more external sensors in order to confirm movement of the pallet and/or determine the new position of the pallet. Other methods of detecting movement of the pallet are also possible. When signals have been transmitted to the server, either by the first pallet or by an external device coupled to an external sensor, to confirm that the first pallet has been moved, the server will transmit reference the database to determine the identity of the next pallet scheduled to be moved and transmit a signal causing the second pallet's control circuit to command the second pallet's display device to display an indicator that the second pallet is to be moved. When movement of the second pallet is confirmed, the server will identify the next pallet to be moved according to the database and transmit a signal to the next pallet to be moved. This process will continue until all pallets have been moved.

The system may be configured so that a display device of a pallet will only display an indicator that it is to be moved upon confirmation that the previous pallet was properly handled. For instance, the server may require specific information regarding the location of a first pallet, and only transmit signals to a second pallet upon confirmation that the first pallet has been relocated to a destination identified in a database as corresponding to the proper destination of the first pallet. Accelerometers, temperature sensors, and other sensors on the pallet intended to monitor the status of goods conveyed on the pallet may also be required to confirm that the goods have not been damaged or subjected to potentially harmful conditions. The control circuits may also be configured to display error signals if the pallets have not been properly relocated or if one or more sensors indicate that the pallet or goods conveyed thereon have been compromised.

Rather than communicating with a server, the plurality of pallets may communicate with one another in order to determine an appropriate sequence of indicators. For instance, the control circuits for each pallet may each reference databases indicating proper order of loading/unloading and trigger their respective displays to display an appropriate indicator only when they have received signals confirming that each pallet identified by the database as being earlier in the loading/unloading sequence has been properly loaded/unloaded.

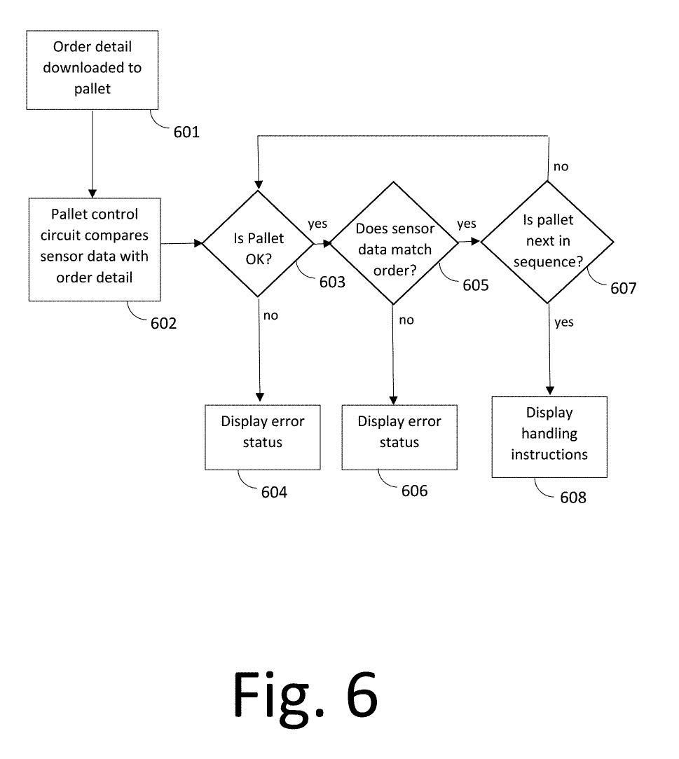

FIG. 6 illustrates an example of a logic system of a pallet that simultaneously monitors conveyed goods and proper loading or unloading sequence in accordance with an aspect of the present invention. Details of an order indicating shipping conditions for conveyed goods and appropriate loading/unloading sequence are downloaded to a pallet (Step 601). A control circuit for the pallet compares data received from one or more sensors with details of the order designated acceptable status or ranges of the characteristics monitored by the sensors (e.g. pallet location, temperature, moisture, etc.) (Step 602). The control circuit determines if the status of the pallet is acceptable, including whether sensors are functional or if there is potential damage to the pallet itself (Step 603). If there is an indication that the pallet is malfunctioning or may have been compromised, an appropriate error status is displayed (Step 604), but if pallet integrity is acceptable the control circuit compares sensor readings to the order to determine if characteristics monitored by the sensors are within acceptable limits (Step 605). If the sensor readings do not match, an error status is displayed (Step 606), which may simply note that at least one error exists or may itemize specific deficiencies in the status of characteristics monitored by sensors (e.g. pallet location, pallet temperature, moisture level, etc.). If the detected status of characteristics matches the order, the pallet control circuit determines if its pallet is the next in the sequence to be loaded or unloaded (Step 607), either by communicating with other pallets or with a server or other external device through a wireless or temporary hard wire connection. If the control circuit determines that its pallet is not designated by the order as the next pallet to be moved, it will continue to monitor its status, returning to Step 603 to verify that systems are functioning properly and then continue to compare detected characteristics with the order. If the control circuit determines that its pallet is the next in the loading or unloading sequence, it will cause the pallet's display to indicate handling instructions (Step 608), for instance by lighting an indicator light or displaying text describing actions to be taken or a destination for the pallet corresponding to the order.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

What is claimed is:

1. A portable pallet structure for conveying and storing a plurality of products at least at a product sales supply chain facility, the structure comprising:
a pallet base configured and sized to carry and support the plurality of products;
the pallet base further configured to be carried and transported by a motorized lift unit;
a control circuit coupled to the pallet base;
a global positioning system unit coupled to the control circuit;
a pressure sensor coupled to the control circuit;
a conductivity meter coupled to the control circuit;
an accelerometer coupled to the control circuit;
a temperature sensor coupled to the control circuit;
a humidity sensor coupled to the control circuit;
a computer memory coupled to the control circuit, the computer memory comprising a database containing data regarding acceptable parameters for readings from at least one of the sensors and including parameters for pallet location, item weight, electrical conductivity, acceleration, temperature, and humidity; and
a display mounted to the pallet structure and coupled to the control circuit, the control circuit configured to cause the display to provide an indicator showing that the readings from one or more of the global positioning system, pressure sensor, conductivity meter, accelerometer, temperature sensor, and humidity sensor match or do not match the acceptable parameters of the database.

2. The portable pallet structure of claim 1, wherein the display comprises a plurality of indicator lights, each indicator light corresponding to one of the global positioning system, pressure sensor, conductivity meter, accelerometer, temperature sensor, and humidity sensor, and wherein the control circuit activates the indicator lights when the readings do not match the acceptable parameters.

3. The portable pallet structure of claim 2, wherein the indicator lights comprise light emitting diodes.

4. The portable pallet structure of claim 1, wherein the display comprises a liquid crystal display screen.

5. The portable pallet structure of claim 1, wherein the display comprises a thin-film-transistor liquid-crystal display.

6. The portable pallet structure of claim 1, wherein the display is a touch-screen display.

7. The portable pallet structure of claim 1, wherein the display comprises a light emitting diode screen.

8. The portable pallet structure of claim 7, wherein the display comprises an organic light emitting diode screen.

9. The portable pallet structure of claim 1, wherein the display is mounted to the pallet base.

10. The portable pallet structure of claim 1, wherein the display is recessed within the pallet base.

11. The portable pallet structure of claim 1, further comprising a plurality of walls extending upwardly from the pallet base.

12. The portable pallet structure of claim 11, wherein the pallet base is configured to couple to a fixed structure.

13. The portable pallet structure of claim 12, wherein the pallet base is configured to couple to a fixed structure.

14. The pallet structure of claim 1, wherein a power source is physically connected to the pallet base and coupled to the display.

15. A portable structure for conveying and storing a plurality of products, the portable structure comprising:
a base configured and sized to carry and support the plurality of products;
a control circuit coupled to the structure;
at least one sensor coupled to the control circuit, the at least one sensor configured to detect at least one of position, pressure, conductivity, acceleration, temperature, or humidity;
a computer memory coupled to the control circuit, the computer memory comprising a database containing data regarding acceptable parameters for readings from the at least one sensor; and
a display physically connected to the structure and coupled to the control circuit, the control circuit configured to cause the display to provide an indicator showing that the readings from the at least one sensor match or do not match the acceptable parameters of the database.

16. The portable structure of claim 15, where in the structure further comprises at least three upstanding walls extending from the base.

17. The portable structure of claim 16, wherein the display is mounted on or within one of the walls.

18. The portable structure of claim 15, wherein the structure is configured to couple to a fixed structure.

19. The portable structure of claim 15, wherein the structure is configured to couple to a fixed shelf.

20. A method of identifying a sequence in which to move a plurality of portable structures in at least a retail chain supply facility, the method comprising:
referencing a database to identify a first portable structure to be moved;
transmitting a signal to a first control circuit of the first portable structure to cause the first control circuit to cause display of a status indicator;
receiving a signal confirming that the first portable structure has been moved; and
referencing the database to identify the next portable structure to be moved.
